(19) United States
(12) Patent Application Publication
(10) Pub. No.: US 2026/0204108 A1
(43) Pub. Date: Jul. 16, 2026

(54) METHOD AND SYSTEM FOR MONITORING THE PERFORMANCE OF A PAIR OF HYDRAULIC ACCUMULATORS ON AN AIRCRAFT

(71) Applicant: Airbus Canada Limited Partnership, MIRABEL (CA)

(72) Inventor: Veronica MARTIN ESTRANA, TOULOUSE (FR)

(21) Appl. No.: 19/445,970

(22) Filed: Jan. 12, 2026

(30) Foreign Application Priority Data
Jan. 14, 2025 (FR) FR2500351

(51) Int. Cl. G07C 5/04; B64D 41/00; B64D 45/00; G01M 3/26

(52) U.S. Cl. CPC G07C 5/04; B64D 41/007; B64D 45/00; G01M 3/26; B64D 2045/0085; B64D 2221/00

(57) ABSTRACT

A method for monitoring the performance of a pair of hydraulic accumulators of an aircraft includes: collecting pressure values from the accumulators during each of N flights of the aircraft, where N≥2; for each of the N flights, calculating a mean pressure value for each of the accumulators; for each of the accumulators, calculating a mean of the N previously calculated mean pressure values; calculating a parameter P which is the absolute value of a difference between the two mean values; calculating a leak indicator which is a function of a difference between the parameter P and a given reference value; and triggering an alert if the indicator is greater than a first predetermined threshold, and not triggering an alert if not.

### CROSS-REFERENCE TO RELATED APPLICATIONS

This application claims the benefit of French Patent Application No. FR2500351, filed on Jan. 14, 2025, the entire disclosure of which is incorporated herein by way of reference.

### FIELD OF THE INVENTION

The field of the invention is that of health monitoring and maintenance of aircraft.

More specifically, the present invention relates to a method for monitoring the performance of a pair of hydraulic accumulators in a hydraulic system of an aircraft that is configured to temporarily deliver hydraulic power in an emergency situation.

The present invention also relates to: a monitoring system designed to implement such a monitoring method; a computer program product and a storage medium used to implement such a monitoring method; and a maintenance method based on such a monitoring method.

### BACKGROUND OF THE INVENTION

Aircraft are subjected to extreme conditions when flying through the air, in particular in terms of variations in temperature, pressure and speed. The performance of aircraft components must be checked regularly to ensure they are working correctly.

Preventive or predictive maintenance involves carrying out checks and repairs before a failure occurs.

In the field of aeronautics, maintenance in particular helps to improve the availability and performance of an aircraft by preventing it from being grounded (AOG for “Aircraft On Ground”) and to reduce maintenance costs by enabling maintenance operations to be identified in advance according to the actual performance of the aircraft.

Monitoring the health of the aircraft for maintenance purposes comprises collecting technical data from the moment the aircraft is powered on, then during flight and until it stops. The data thus collected are in particular used to calculate the various indicators on which maintenance is based, and therefore the scheduling of maintenance operations.

The data may be used during the flight (“in-flight health monitoring”) and/or after the flight (for example, if the volume of data to be processed requires greater computational resources). Calculations using the collected data may therefore be carried out in the aircraft and/or in one or more devices on the ground. In the second case, the devices (computers) on the ground receive, in real time or with a delay, the data collected in the aircraft.

Observing the health of an aircraft over a plurality of flights allows personnel on the ground to make decisions and to plan maintenance operations in advance, thereby saving valuable execution time. The personnel on the ground may thus make appropriate decisions based on criticality, logistics and upcoming maintenance checks, and prepare for repairs and replacements in advance.

In the context of this maintenance work, there is in particular a need to monitor the performance of a pair of hydraulic accumulators in a hydraulic system of an aircraft that is configured to temporarily deliver hydraulic power in an emergency situation. To do this, a solution should be provided that is reliable and simple to implement, and that enables possible operational interruptions to be anticipated by raising maintenance alerts (for example in the event of a leak from one of the hydraulic accumulators of the monitored pair) sufficiently in advance.

### SUMMARY OF THE INVENTION

A method is proposed for monitoring a performance of a pair of hydraulic accumulators in a hydraulic system of an aircraft, the pair of hydraulic accumulators comprising first and second hydraulic accumulators configured to temporarily deliver hydraulic power in an emergency situation, the method being implemented by a monitoring system comprising electronic circuitry, the method including:
collecting pressure values from the first and second hydraulic accumulators during each of N flights of the aircraft, where N≥2, the pressure values being provided by pressure sensors fitted to the aircraft;
for each of the N flights, calculating a mean pressure value for each of the first and second hydraulic accumulators, as a function of pressure values contained in a determined time interval of the flight;
for each of the first and second hydraulic accumulators, calculating a mean, denoted M1 for the first hydraulic accumulator and M2 for the second hydraulic accumulator, of the N mean pressure values calculated for the N flights;
calculating a parameter P, which is the absolute value of a difference between the means M1 and M2 calculated for the first and second hydraulic accumulators;
calculating a leak indicator which is a function of a difference between the parameter P and a given reference value; and
triggering an alert if the leak indicator is greater than a first predetermined threshold, and not triggering an alert if the leak indicator is less than or equal to the first predetermined threshold.

This enables the performance of a pair of hydraulic accumulators in a hydraulic system of an aircraft to be monitored using a solution which is reliable and simple to implement, and which makes it possible to anticipate possible operational interruptions by raising maintenance alerts sufficiently in advance.

According to a specific embodiment, the method comprises, for each of the N flights: determining the time interval as being within a final phase of the flight and as containing pressure values that satisfy a set of criteria defining a constant nature of the pressure of the first and second hydraulic accumulators.

According to one particular embodiment, for each of the N flights, the mean pressure value calculated for each of the first and second hydraulic accumulators is a mean of a maximum pressure value and a minimum pressure value of the pressure values contained in the determined time interval of the flight.

According to one particular embodiment, the reference value is determined as the parameter P calculated for the first flight following an observation of a revision of at least one of the first and second hydraulic accumulators.

According to one particular embodiment, a revision of a given hydraulic accumulator, of the first and second hydraulic accumulators, is observed if the following three conditions are satisfied:
the absolute value of a difference between a mean pressure value for the given hydraulic accumulator during a flight in position F and a mean pressure value for the given hydraulic accumulator during a flight in position F−2 is greater than a second predetermined threshold;
the absolute value of a difference between the mean pressure value for the given hydraulic accumulator during the flight in position F and a mean pressure value for the given hydraulic accumulator during a flight in position F−1 is greater than a third predetermined threshold, which is in turn greater than the second predetermined threshold; and
the absolute value of a difference between the mean pressure value for the given hydraulic accumulator during the flight in position F and a mean pressure value for the given hydraulic accumulator during a flight in position F+1 is less than the third predetermined threshold.

According to one particular embodiment, triggering an alert comprises:
triggering a first alert indicating a leak from the first hydraulic accumulator if the leak indicator is greater than the first predetermined threshold and if the mean M1 calculated for the first hydraulic accumulator is less than the mean M2 calculated for the second hydraulic accumulator; and
triggering a second alert indicating a leak from the second hydraulic accumulator if the leak indicator is greater than the first predetermined threshold and if the mean M1 calculated for the first hydraulic accumulator is greater than the mean M2 calculated for the second hydraulic accumulator.

According to one particular embodiment, at least two iterations of the collection, calculations and triggering or non-triggering of an alert are performed, each iteration being performed using a particular composition of a sliding window of N flights.

According to one particular embodiment, the hydraulic system comprises a main pump, a backup pump and a third pump connected to a ram air turbine, and wherein the emergency situation is a situation in which the main pump and the backup pump are not operational and the third pump connected to the ram air turbine is not yet completely operational.

Also proposed is a computer program product including instructions which cause the monitoring method discussed above according to any one of its embodiments to be executed by a processor when said instructions are executed by the processor.

Also proposed is a storage medium storing such instructions.

Also proposed is a system for monitoring a performance of a pair of hydraulic accumulators in a hydraulic system of an aircraft, the pair of hydraulic accumulators comprising first and second hydraulic accumulators configured to temporarily deliver hydraulic power in an emergency situation, the monitoring system comprising electronic circuitry configured to implement:
collecting pressure values from the first and second hydraulic accumulators during each of N flights of the aircraft, where N≥2, the pressure values being provided by pressure sensors fitted to the aircraft;
for each of the N flights, calculating a mean pressure value for each of the first and second hydraulic accumulators, as a function of pressure values contained in a determined time interval of the flight;
for each of the first and second hydraulic accumulators, calculating a mean, denoted M1 for the first hydraulic accumulator and M2 for the second hydraulic accumulator, of the N mean pressure values calculated for the N flights;
calculating a parameter P, which is the absolute value of a difference between the means M1 and M2 calculated for the first and second hydraulic accumulators;
calculating a leak indicator which is a function of a difference between the parameter P and a given reference value; and
triggering an alert if the leak indicator is greater than a first predetermined threshold, and not triggering an alert if the leak indicator is less than or equal to the first predetermined threshold.

Also proposed is a method for maintaining a pair of hydraulic accumulators in a hydraulic system of an aircraft, the pair of hydraulic accumulators comprising first and second hydraulic accumulators configured to temporarily deliver hydraulic power in an emergency situation, the maintenance method including:
executing the monitoring method discussed above according to any one of its embodiments, to monitor the performance of the pair of hydraulic accumulators; and
in the event that an alert relating to the performance of the pair of hydraulic accumulators is triggered, performing at least one maintenance operation on at least one of the hydraulic accumulators of the pair of hydraulic accumulators.

### BRIEF DESCRIPTION OF THE DRAWINGS

The above-mentioned features of the invention, as well as others, will become more clearly apparent on reading the following description of at least one example embodiment, said description being given with reference to the appended drawings, in which:

FIG. 1 schematically illustrates a side view of an aircraft equipped with a system for monitoring the performance of a pair of hydraulic accumulators of a hydraulic system of the aircraft;

FIG. 2 schematically illustrates one embodiment of the hydraulic system of the aircraft in FIG. 1;

FIG. 3 schematically illustrates an example of the hardware architecture of the monitoring system in FIG. 1;

FIG. 4 schematically illustrates an example monitoring algorithm executed by the monitoring system in FIG. 1; and

FIG. 5 schematically illustrates an example maintenance algorithm for a pair of hydraulic accumulators of a hydraulic system of an aircraft.

### DETAILED DESCRIPTION OF EMBODIMENTS

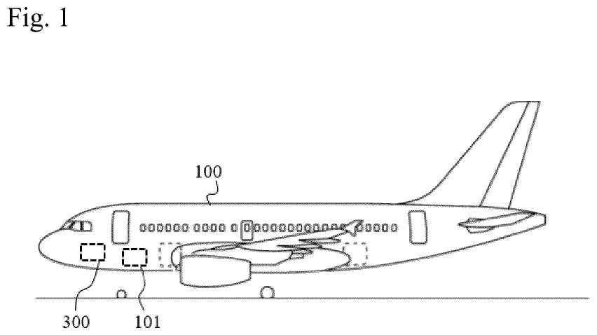

FIG. 1 schematically illustrates a side view of an aircraft 100 fitted with a system 300 for monitoring the performance of a pair of hydraulic accumulators in a hydraulic system 101 that is configured to temporarily deliver hydraulic power in an emergency situation.

As described in detail below, the monitoring system 300 triggers an alert (for example by displaying information and/or sending a message to a maintenance department) if a triggering condition is satisfied. Furthermore, as also detailed below, the triggering of an alert relating to the pair of hydraulic accumulators may be followed by at least one maintenance operation on this pair of hydraulic accumulators (for example the repair or replacement of one of the hydraulic accumulators of the monitored pair).

In one particular embodiment, the monitoring system 300 is an on-board electronic device. For example, it forms part of electronic circuitry of the avionics of the aircraft 100. Preferentially, it is integrated into a computer of the aircraft 100.

In one variant, the monitoring system 300 is not on board the aircraft 100 but is present on the ground.

In another variant, the monitoring system 300 comprises a first part which is on board the aircraft 100 and a second part which is present on the ground. Thus, the calculations and the triggering of the alerts may be distributed between the two parts of the monitoring system 300.

In another variant, at least one monitoring system 300 is on board the aircraft and at least one monitoring system is installed on the ground.

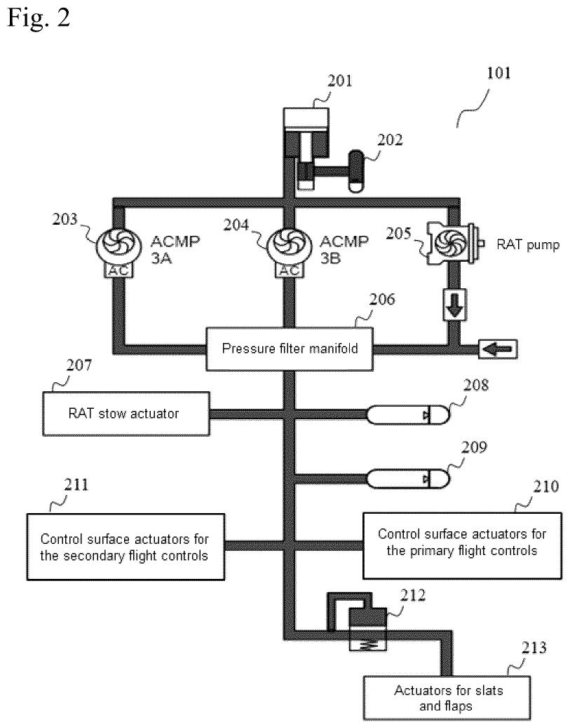

In the particular embodiment illustrated schematically in FIG. 2, the hydraulic system 101 is a particular hydraulic system referred to as “hydraulic system 3”. It will be recalled that an aircraft generally comprises a plurality of independent hydraulic systems used to actuate almost all of the movable elements necessary for flight, such as the landing gear, the brakes, the flaps, the lift dumpers (spoilers), the flight control surfaces, etc. Each hydraulic system has its own reservoir, containing a pressurized hydraulic fluid used to transmit the power and the force from one point to another. In order to comply with certification standards aimed at minimizing the consequences of a fault, an aircraft typically has three hydraulic systems, referred to as hydraulic systems 1, 2 and 3 respectively, designed to enable the crew to keep control of the aircraft in the event of a failure of one (or even two) of said systems.

In the embodiment in FIG. 2, the hydraulic system 101 (“hydraulic system 3”) comprises:
the pair of hydraulic accumulators 208 and 209 being monitored (piston-type nitrogen accumulators, for example);
a main pump 203 with an AC motor, referred to as “ACMP 3A” (for “alternating current motor pump 3A”);
a backup pump 204 with an AC motor, referred to as “ACMP 3B” (for “alternating current motor pump 3B”);
a third pump 205, referred to as a “RAT pump” as it is connected to a ram air turbine (RAT);
a reservoir 201, containing a pressurized hydraulic fluid and cooperating with an accumulator 202 performing several functions (storing and releasing the pressurized fluid in order to maintain the pressure of the hydraulic system, absorbing shocks and surges, and delivering auxiliary power during demand spikes) different from the function performed by the pair of accumulators 208 and 209 being monitored by the monitoring system 300 (namely temporarily delivering hydraulic power in an emergency situation);
a pressure filter manifold 206;
a RAT stow actuator 207;
a block 210 of control surface actuators for the primary flight controls;
a block 211 of control surface actuators for the secondary flight controls;
a priority valve 212; and
a block 213 of actuators for the slats and flaps.

In this context, the aforementioned emergency situation (in which the pair of hydraulic accumulators 208 and 209 temporarily deliver hydraulic power) is a situation in which the main pump 203 (ACMP 3A) and the backup pump 204 (ACMP 3B) are not operational (for example due to a double engine failure) and the RAT pump 205 is not yet fully operational.

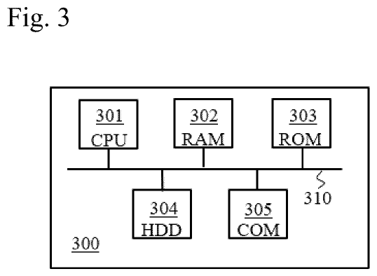

FIG. 3 schematically illustrates one example of the hardware architecture of the monitoring system 300 in FIG. 1, which then comprises the following, connected by a communication bus 310: a processor or central processing unit (CPU) 301; a random access memory RAM 302; a read-only memory ROM 303, for example a flash memory; a data storage device, such as a hard disk drive (HDD), or a storage medium reader, such as a secure digital (SD) card reader 304; at least one communication interface 305 allowing the monitoring system 300 to interact with the avionics of the aircraft 100.

The processor 301 is capable of executing instructions loaded into the RAM 302 from the ROM 303, from an external memory (not shown), from a storage medium, such as an SD card, or from a communication network (not shown). When the monitoring system 300 is powered up, the processor 301 is capable of reading instructions from the RAM 302 and of executing them. These instructions form a computer program which causes the behaviors, steps and algorithm described here to be implemented by the processor 301.

All or some of the behaviors, steps and algorithm described here may thus be implemented in software form by executing a set of instructions using a programmable machine, such as a digital signal processor (DSP) or a microcontroller, or be implemented in hardware form by a machine or a dedicated component (“chip”) or a dedicated set of components (“chipset”), such as a field-programmable gate array (FPGA) or an application-specific integrated circuit (ASIC). Generally, the monitoring system 300 comprises electronic circuitry arranged and configured to implement the behaviors, steps and algorithms described here.

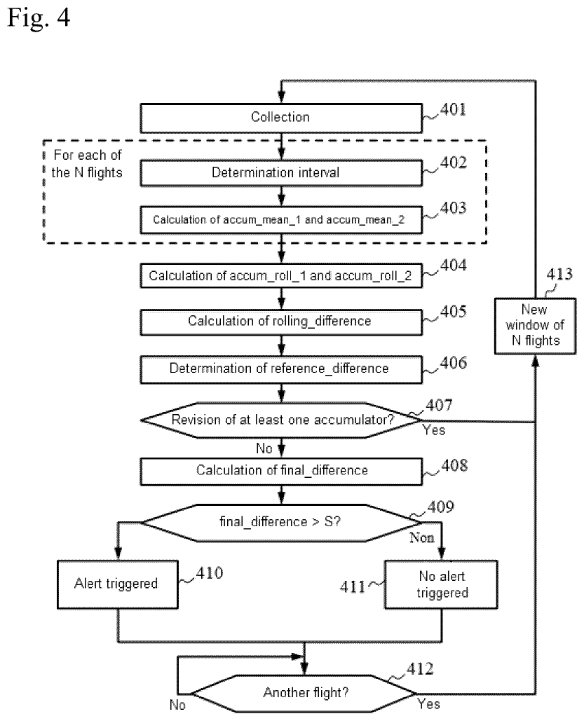

FIG. 4 schematically illustrates an example algorithm for monitoring the performance of the pair of hydraulic accumulators 208 and 209 included in the hydraulic system 101 in FIG. 2. The algorithm (method) is implemented by the monitoring system 300 discussed above in relation to FIGS. 1 and 3.

In a step 401, the monitoring system 300 collects pressure values from the two hydraulic accumulators 208 and 209 during each of N flights of the aircraft, where N≥2 (for example, N=20). The pressure values are provided by pressure sensors fitted to the aircraft 100.

The following two steps 402 and 403 are executed for each of the N flights.

In step 402, the monitoring system 300 determines a particular time interval of the flight under consideration. In one embodiment, it is a time interval during a final phase of the flight containing pressure values that satisfy a set of criteria defining a constant nature of the pressure of the two hydraulic accumulators 208 and 209. For example, it is the last 10 s time interval of the succession of 10 s time intervals forming the last ten minutes of the flight, containing pressure values that satisfy the following set of criteria (comprising three cumulative conditions):
for each of the hydraulic accumulators 208 and 209: 0≤accum_cnt_max_j−accum_cnt_min_j≤S1 (for example, S1=30 psig); AND
for each of the hydraulic accumulators 208 and 209: accum_cnt_max_j<S2, where S2>S1 (for example, S2=2000 psig); AND
for each of the hydraulic accumulators 208 and 209: accum_cnt_min_j>0 psig;
where accum_cnt_max_j and accum_cnt_min_j are the maximum pressure value and the minimum pressure value respectively of the pressure values contained in the considered time interval, where j is equal to 1 for the hydraulic accumulator 208 and j is equal to 2 for the hydraulic accumulator 209.

In step 403, for each of the two hydraulic accumulators 208 and 209, the monitoring system 300 calculates a mean pressure value (denoted accum_mean_j, where j is equal to 1 for the hydraulic accumulator 208 and j is equal to 2 for the hydraulic accumulator 209), as a function of pressure values in the time interval determined in step 402. In one embodiment, the mean pressure value accum_mean_j, where j is equal to 1 or 2, calculated for each of the hydraulic accumulators is a mean of the maximum pressure value accum_cnt_max_j and the minimum pressure value accum_cnt_min_j of the pressure values in the time interval determined in step 402.

In a step 404, for each of the hydraulic accumulators 208 and 209, the monitoring system 300 calculates a mean (denoted accum_roll_1 for the hydraulic accumulator 208 and accum_roll_2 for the hydraulic accumulator 209) of the N mean pressure values calculated for the N flights (i.e. the N values of accum_mean_1 for the hydraulic accumulator 208 and the N values of accum_mean_2 for the hydraulic accumulator 209, calculated in the N iterations of step 403).

In a step 405, the monitoring system 300 calculates a parameter denoted rolling_difference, which is the absolute value of a difference between the means accum_roll_1 and accum_roll_2 calculated in step 404.

In a step 406, the monitoring system 300 determines a reference value, denoted reference_difference, which is equal to the parameter rolling_difference calculated for the first flight that follows an observation of a revision of at least one of the two hydraulic accumulators 208 and 209.

In a step 407, the monitoring system 300 determines whether a revision (i.e. a maintenance operation) of at least one of the hydraulic accumulators 208 and 209 is observed. In one embodiment, a revision of a given hydraulic accumulator, of the hydraulic accumulators 208 and 209, is observed if the following three cumulative conditions are satisfied:
the absolute value of a difference between a mean pressure value (denoted accum_mean_j_F) for the given hydraulic accumulator during a flight in position F and a mean pressure value (denoted accum_mean_j_F−2) for the given hydraulic accumulator during a flight in position F−2 is greater than a predetermined threshold denoted low_threshold (for example, low_threshold=180 psig). This first condition is written: abs(accum_mean_j_F−accum_mean_j_F−2)>low_threshold; AND
the absolute value of a difference between the mean pressure value (denoted accum_mean_j_F) for the given hydraulic accumulator during the flight in position F and a mean pressure value (denoted accum_mean_j_F−1) for the given hydraulic accumulator during a flight in position F−1 is greater than another predetermined threshold denoted high_threshold (for example, high_threshold=200 psig), which is in turn greater than the threshold low_threshold. This second condition is written: abs(accum_mean_j_F−accum_mean_j_F−1)>high_threshold; AND
the absolute value of a difference between the mean pressure value (denoted accum_mean_j_F) for the given hydraulic accumulator during the flight in position F and a mean pressure value (denoted accum_mean_j_F+1) for the given hydraulic accumulator during a flight in position F+1 is less than the threshold high_threshold. This third condition is written: abs(accum_mean_j_F−accum_mean_j_F+1)<high_threshold.

The third condition is used to check that the value accum_mean_j_F is not an outlier that should be disregarded.

If a revision (i.e. a maintenance operation, as indicated above in the description of step 407) of at least one of the hydraulic accumulators 208 and 209 is observed in step 407, the monitoring system 300 moves directly to step 413 described below. In other words, the monitoring system 300 performs a new iteration of steps 401 to 406 (with a new window of N flights including the new flight and the N−1 preceding flights). Thus, in the new iteration of step 406, the monitoring system 300 determines a reference value, which will be different from the preceding value since it is equal to the parameter rolling_difference calculated for the first flight that follows an observation of a revision of at least one of the two hydraulic accumulators 208 and 209.

If no revision of the hydraulic accumulators 208 and 209 is observed in step 407, the monitoring system 300 moves to step 408, in which it calculates a leak indicator, denoted final_difference, which is a function of a difference between the parameter rolling_difference and the reference value reference_difference. In one embodiment, final_difference=rolling_difference−reference_difference.

After step 408, the monitoring system 300 moves to step 409 in which it determines whether the leak indicator final_difference is greater than a predetermined threshold S (for example, S=35 psig).

If the leak indicator final_difference is less than or equal to the threshold S (“no” response to the test in step 409), the monitoring system 300 moves to step 411 in which it does not trigger an alert.

If the leak indicator final_difference is greater than the threshold S (“yes” response to the test in step 409), the monitoring system 300 moves to step 410 in which it triggers an alert. In one embodiment, triggering an alert in step 410 comprises:
triggering a first alert indicating a leak from the hydraulic accumulator 208 if the leak indicator final_difference is greater than the threshold S and if the mean accum_roll_1 calculated for the hydraulic accumulator 208 is less than the mean accum_roll_2 calculated for the hydraulic accumulator 209; and
triggering a second alert indicating a leak from the hydraulic accumulator 209 if the leak indicator final_difference is greater than the threshold S and if the mean accum_roll_1 calculated for the hydraulic accumulator 208 is greater than the mean accum_roll_2 calculated for the hydraulic accumulator 209.

On completion of step 410 or step 411 (depending on the result of the test in step 409), the monitoring system 300 moves to step 412 in which it determines whether there is a new flight to be processed.

As long as there is no new flight to be processed (“no” response to the test in step 412), the monitoring system 300 loops back to step 412. If there is a new flight to be processed (“yes” response to the test in step 412), the monitoring system 300 moves to step 413, in which it determines a new window of N flights including the new flight and the N−1 previous flights (in other words, a sliding window of N flights is used), then it returns to step 401 for a new iteration of the various steps of the method.

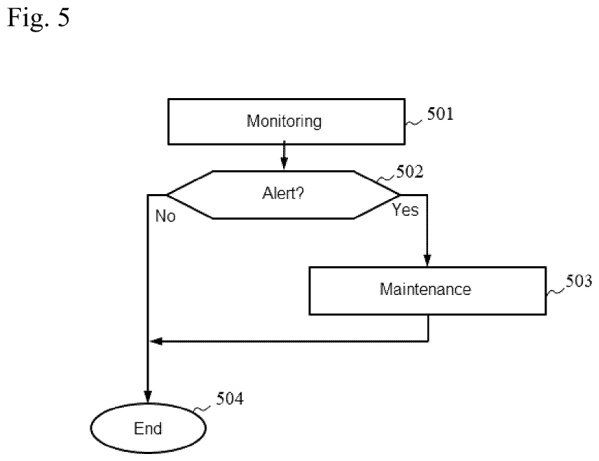

FIG. 5 schematically illustrates an example maintenance algorithm for the pair of hydraulic accumulators 208 and 209 in the hydraulic system 101 in FIG. 2.

In a step 501, the monitoring system 300 executes the algorithm for monitoring the performance of the pair of hydraulic accumulators, for example in the particular embodiment described above (see the description of FIG. 4).

If an alert has been triggered at the end of step 501 (“yes” result in test step 502), at least one maintenance operation is performed (step 503) on at least one accumulator of the pair of hydraulic accumulators. Otherwise (“no” result in test step 502), this is the end step 504 directly.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for monitoring a performance of a pair of hydraulic accumulators in a hydraulic system of an aircraft, the pair of hydraulic accumulators comprising a first hydraulic accumulator and a second hydraulic accumulator configured to temporarily deliver hydraulic power in an emergency situation, the method being implemented by a monitoring system comprising electronic circuitry, the method comprising:
collecting pressure values from the first hydraulic accumulator and the second hydraulic accumulator during each of N flights of the aircraft, where N≥2, the pressure values being provided by pressure sensors fitted to the aircraft;
for each of the N flights, calculating a mean pressure value (accum_mean_j) for each of the first hydraulic accumulator and the second hydraulic accumulator, as a function of pressure values contained in a determined time interval of a flight;
each of the first hydraulic accumulator and the second hydraulic accumulator, calculating a mean, denoted M1 (accum_roll_1) for the first hydraulic accumulator and M2 (accum_roll_2) for the second hydraulic accumulator, of the N mean pressure values calculated for the N flights;
calculating a parameter P (rolling_difference), which is an absolute value of a difference between the means M1 and M2 calculated for the first hydraulic accumulator and the second hydraulic accumulator;
calculating a leak indicator (final_difference) which is a function of a difference between the parameter P (rolling_difference) and a determined reference value (reference_difference); and
triggering an alert when the leak indicator is greater than a first predetermined threshold, and not triggering an alert when the leak indicator is less than or equal to the first predetermined threshold.

2. The method according to claim 1, further comprising:
for each of the N flights: determining the time interval as being within a final phase of the flight and as containing pressure values that satisfy a set of criteria defining a constant nature of the pressure of the first hydraulic accumulator and the second hydraulic accumulator.

3. The method according to claim 1, wherein, for each of the N flights, the mean pressure value (accum_mean_j) calculated for each of the first hydraulic accumulator and the second hydraulic accumulator is a mean of a maximum pressure value and a minimum pressure value of the pressure values contained in the determined time interval of the flight.

4. The method according to claim 1, wherein the reference value (reference_difference) is determined as the parameter P calculated for a first flight following an observation of a revision of at least one of the first hydraulic accumulator and the second hydraulic accumulator.

5. The method according to claim 4, wherein a revision of a given hydraulic accumulator, of the first hydraulic accumulator or the second hydraulic accumulator, is observed when the following three conditions are satisfied:
an absolute value of a difference between a mean pressure value for the given hydraulic accumulator during a flight in position F and a mean pressure value for the given hydraulic accumulator during a flight in position F−2 is greater than a second predetermined threshold;
an absolute value of a difference between the mean pressure value for the given hydraulic accumulator during the flight in position F and a mean pressure value for the given hydraulic accumulator during a flight in position F−1 is greater than a third predetermined threshold, which is in turn greater than the second predetermined threshold; and
an absolute value of a difference between the mean pressure value for the given hydraulic accumulator during the flight in position F and a mean pressure value for the given hydraulic accumulator during a flight in position F+1 is less than the third predetermined threshold.

6. The method according to claim 1, wherein triggering an alert comprises:
triggering a first alert indicating a leak from the first hydraulic accumulator when the leak indicator is greater than the first predetermined threshold and when the mean M1 calculated for the first hydraulic accumulator is less than the mean M2 calculated for the second hydraulic accumulator; and
triggering a second alert indicating a leak from the second hydraulic accumulator when the leak indicator is greater than the first predetermined threshold and when the mean M1 calculated for the first hydraulic accumulator is greater than the mean M2 calculated for the second hydraulic accumulator.

7. The method according to claim 1, wherein at least two iterations of the collecting, calculating, and triggering or non-triggering of an alert are performed, each iteration being performed using a particular composition of a sliding window of N flights.

8. The method according to claim 1, wherein the hydraulic system comprises:
a main pump, a backup pump, and a third pump connected to a ram air turbine, and
wherein the emergency situation is a situation in which the main pump and the backup pump are not operational and the third pump connected to the ram air turbine is not yet completely operational.

9. A non-transitory computer readable medium storing a computer program comprising instructions which cause a processor to perform the method of claim 1 when the instructs are executed by the processor.

10. The method of claim 1 further comprising
when an alert relating to the performance of the pair of hydraulic accumulators is triggered, performing at least one maintenance operation on at least one of the first hydraulic accumulator and the second hydraulic accumulator.

11. A system for monitoring a performance of a pair of hydraulic accumulators in a hydraulic system of an aircraft, the pair of hydraulic accumulators comprising a first hydraulic accumulator and a second hydraulic accumulator configured to temporarily deliver hydraulic power in an emergency situation, the system comprising electronic circuitry configured to:
collect pressure values from the first hydraulic accumulator and the second hydraulic accumulator during each of N flights of the aircraft, where N≥2, the pressure values being provided by pressure sensors fitted to the aircraft;
for each of the N flights, calculate a mean pressure value (accum_mean) for each of the first hydraulic accumulator and the second hydraulic accumulator, as a function of pressure values contained in a determined time interval of a flight;
for each of the first hydraulic accumulator and the second hydraulic accumulator, calculate a mean, denoted M1 (accum_roll_1) for the first hydraulic accumulator and M2 (accum_roll_2) for the second hydraulic accumulator, of the N mean pressure values calculated for the N flights;
calculate a parameter P (rolling_difference), which is an absolute value of a difference between the means M1 and M2 calculated for the first hydraulic accumulator and the second hydraulic accumulator;
calculate a leak indicator (final_difference) which is a function of a difference between the parameter P (rolling_difference) and a determined reference value (reference_difference); and
trigger an alert when the leak indicator is greater than a first predetermined threshold, and not trigger an alert when the leak indicator is less than or equal to the first predetermined threshold.
